(19) United States
(12) Patent Application Publication
(10) Pub. No.: US 2026/0105134 A1
(43) Pub. Date: Apr. 16, 2026

(54) METHOD AND SYSTEM FOR MULTI - DIMENSION AUTHENTICATION BASED ON SINGLE USER ACTION

(71) Applicant: BALDEV KRISHAN, Pleasanton, CA (US)

(72) Inventor: BALDEV KRISHAN, Pleasanton, CA (US)

(21) Appl. No.: 18/914,667

(22) Filed: Oct. 14, 2024

(51) Int. Cl. G06F 21/32

(52) U.S. Cl. CPC G06F 21/32

(57) ABSTRACT

A method and system for performing multi-dimension authentication based on a single user action. The system utilizes a unique user action, such as a gesture or biometric input, to verify the identity of the user. This single-action authentication method increases security and convenience by eliminating the need for multiple steps or inputs typically required for authentication. The system enables a method for performing user authentication based on single user action, wherein the system uses more than one level of authentication process with a single user action, which receives the credentials from the user and authorizes them to allow access to the various applications which are used by the user. The authentication system grants access to the user's details including the name of the user, the unique ID of the mobile device, location, and real-time stamp. The authentication system permits the user to access digital content and system, computing systems and devices and physical locations using only the user's mobile device. The mobile device runs a mobile application that performs the authentication functionality using single or multiple biometrics features like face, iris, speech and fingerprint recognition captured using the mobile device.

### CROSS-REFERENCE TO RELATED APPLICATION

This application claims the benefit of U.S. Provisional Ser. No. 63/444,999 , filed on Feb. 13, 2013, the entire contents of which are incorporated herein by reference.

### TECHNICAL FIELD

The present invention relates to the field cyber security, specifically in the domain of authentication and security measures. More particularly, the present invention relates to a system and method for multi-dimension authentication based on single user action.

### BACKGROUND

Authentication method typically involve verifying the identity of a user before granting access to a system or sensitive information that is a crucial aspect of information security, ensuring that only authorized individuals or entities gain access to sensitive systems, data or services. Traditional authentication methods, often rely on a single factor, such as using a password or security token that can be easily forgotten, compromised, or hacked by a third party. Hence, there has been a growing demand for a more convenient and secure methods of user authentication.

Furthermore, modern technology has made it harder to restrict access to digital information, computing devices and even physical locations. This is because advanced computing systems and the Internet have made it easier to access digital information.

Within the current computing environment, where numerous applications utilize web-based user interfaces accessible through common browsers. In response to the growing need for secure authentication, many systems have adopted user-friendly web-based interfaces to streamline the login process. However, despite the convenience of these interfaces, users often encounter multiple authentication processes, which can lead to significant inconvenience.

In a typical scenario, a user may access various applications, services, or websites, each requiring its own authentication method. These methods could include traditional username and password combinations, two-factor authentication involving codes sent via SMS or authenticator apps, biometric verification like fingerprint or facial recognition, or even knowledge-based authentication questions. While each of these methods contributes to heightened security, the cumulative effect of subjecting users to multiple authentication processes within a short time frame can lead to inconvenience and frustration.

Users, accustomed to seamless and efficient experiences, may find the need to navigate through diverse authentication methods cumbersome and time-consuming. This complexity can potentially discourage users, impacting their overall satisfaction and usability of the applications. Striking a balance between security and user convenience remains a challenge in the design and implementation of authentication systems in web-based environments.

Additionally, regarding physical authorization several approaches exist such as access to user ID and passwords, concerning access to digital content and computer devices and systems, and unique usernames and password combinations that may help protect against unauthorized access. However, users often forget usernames and passwords as users typically have multiple online accounts, each with a different username and password. Also, the users may leave their usernames and passwords in plain view or may use generic passwords that can be easily determined. While solutions such as biometrics, token generator and one-time passwords (OTP) have been developed, these solutions are prone to be tampered with and/or hacked. Also, these solutions are often overly complex and costly and may even require users to carry separate devices that generate tokens or passwords, which can be easily misplaced. However, these systems require a computing device that is prone to the same vulnerabilities described above concerning digital authentication.

In the current internet system, websites authenticate their users by requiring a password and browsers authenticate websites through a Secure protocol.

The sensitive data has to be safeguarded in this rapidly expanding network of connected devices which needs the development of a secure authentication system which is safe to use.

The identity market has needed disruption for years. Data security has altered from passwords to fragmented solutions that inconvenience users and still do not definitively provide “proof of user identity.”

In today's time, biometrics must be used, but it is necessary to take a fresh look at how to best capture biometrics and take advantage of the real-time authentication context to create the highest security possible.

There have been new ways to authenticate users based on their unique physical characteristics.

One such approach is to use biometric data, such as a fingerprint or facial recognition, as the sole means of identifying and authenticating a user. This approach is known as single-user action authentication. Single-user action authentication systems rely on the use of specialized hardware, such as fingerprint scanners or facial recognition cameras, to capture and analyze biometric data. The collected data is then compared to a pre-existing template of the user's biometric information. If the data matches the template, the system grants access to the user.

The development of single-user action authentication systems has been driven by advances in technology, such as the miniaturization of sensors and the improvement of machine learning algorithms. These advancements have made it possible to create systems that are both accurate and convenient to use. Single-user action authentication systems are increasingly being adopted in a variety of industries, including banking, healthcare, and government.

Single-user action authentication systems have several advantages over traditional methods of authentication. They are more secure because they rely on unique physical characteristics that are difficult to imitate or steal. They are also more convenient because they do not require the user to remember a password or carry a security token.

However, single-user action authentication systems also have some limitations. They require specialized hardware, which can be expensive to purchase and maintain. They also raise privacy concerns because they rely on the collection and storage of sensitive biometric data.

Despite these limitations, single-user action authentication systems are expected to play an increasingly important role in the field of user authentication in the future. With the continued development of technology and the growing need for more convenient and secure methods of authentication, single-user action authentication systems are poised to become a standard in the industry.

Also, there is a need for improved methods and systems for performing user authentication involving a simple authentication process that is cost-efficient, and less susceptible to hacking and unauthorized password sharing.

Therefore, to solve the above-mentioned limitations the present invention discloses a system and method for multi-dimension user authentication, particularly based on single-user action.

### SUMMARY OF THE INVENTION

The need in the art is addressed by the system and method for multi-dimension authentication based on single user action.

In one embodiment, the present invention discloses a system and method for multi-dimension authentication based on single user action for authenticating user to access website, web-portal, applications, and any other services utilizing a mobile device owned by a user. The system includes a network of registered user's which are linked with the computing systems, and authenticates users by validating real-time physical location, and device ID which is unique to a user's mobile device and timestamp.

In yet another embodiment, the system for multi-dimension authentication includes a mobile device, equipped with at-least one biometric sensors that run a user authentication application to performs multi-dimension authentication tasks and communicates with at least one other computing device to access website, web-portal, and applications including the IoT devices or android device utilized by the user upon successful authentication by single user action. The unique concept of the present invention is the multi-dimension authentication system and method that authenticate users to access website, web-portal, and applications including the IoT devices or android device, user's name linked with the computing systems, real-time physical location, and device ID with a single user action, such as interacting with a mobile device, thereby eliminating the need for multiple interaction with authentication system.

In yet another embodiment, the system for multi-dimension authentication preferably includes an application that runs on at least one mobile device having at least one biometric sensor and one computing device that may be an interface device. The mobile device runs a mobile application and includes a display having a user interface. The system for multi-dimension authentication may further include software that runs on at least one server that communication with the mobile device. The mobile device is in communication with the computing device or interface device. The server is in communication with the computing device or interface device and may be in communication with the mobile device.

In yet another embodiment, the authentication system provides access to a website or web portal. To access the website or web portal, the user needs to download the mobile application to the mobile device. Using the mobile application, the user will set up a user profile and provide user identification information, authentication data which includes biometric data, and credential information (e.g., website usernames and passwords) to access certain websites or web portals. The user identification information (e.g., phone number and/or any other unique mobile device identifier) and the credential information will be shared with the server. The authentication data will be saved on the mobile device.

In yet another embodiment, the request for authentication data will be sent to the mobile device and the mobile application will prompt the user to generate authentication data including biometric information using biometric sensors like Face ID, Fingerprints from iPhone or Android devices. Further, the mobile application will compare the authentication data generated to the authentication data in the user's profile to validate the authentication data.

In yet another embodiment, the mobile application will capture this information and transmits it to the server, notifying that the user has been validated and the information will be sent to the server.

In yet another embodiment, the method of multi-dimension authentication involves the steps of capturing the user's biometrics using mobile device equipped with biometric sensor at the user's end point, wherein the capturing of biometric data includes two levels of user authentication including native mobile biometrics and other modalities. The native mobile biometrics includes face recognition from iPhone or Android mobile device and fingerprint recognition from iPhone or android mobile device. The other modalities include speech, iris, or behavioural recognition using biometrics sensor inbuilt in mobile device. Upon successful validation of the two levels of user authentication, the user is granted access to the website, web-portal, or any other computing network.

In yet another embodiment, a non-transient memory medium operatively coupled to at least one processor in the computing device may be configured to store a plurality of instructions to perform the foregoing operation and tasks.

### BRIEF DESCRIPTION OF THE DRAWINGS

FIG. 1 is a flow chart illustrating the operations made for downloading and registering the mobile application. Upon downloading the mobile application, user details are entered, and the user profile is verified. Further, the mobile device captures biometric data and with this the registration is complete.

FIG. 2 illustrates a flow chart depicting identity verification using five-dimensions of identity from only one user action. This identity validation platform works when the mobile application receives a validation request from a trusted source, immediately the user authenticates the biometric feature on mobile device using multiple modalities like face ID, fingerprint recognition. Once the biometric details are captured, the data is compared with the registered user data (locally or through the server). The user details like Time, GPS co-ordinates, Device ID are captured only after user biometric data is verified and then sent to the server.

The foregoing and other features of the present invention will become apparent from the following description and appended claims, taken in conjunction with the accompanying drawings. Understanding that these drawings depict only several documents in accordance with the disclosure and are; therefore, not to be considered limiting of its scope, the disclosure will be described with additional specificity and detail through use of the accompanying drawings.

### DETAILED DESCRIPTION OF THE INVENTION

The present invention is directed to a system and method for multi-dimension authentication based on single user action. The multi-dimension authentication process authenticates the user to access website, web-portal, and applications utilizing the mobile device owned by the user. The invention is herein described with numerous specific details to provide a complete understanding of the invention.

However, these specific details are exemplary and should not be treated as the limitation to the scope of the invention. Throughout this specification the word “comprise” or variations such as “comprises or comprising”, will be understood to imply the inclusions of a stated element, integer or step, or group of elements, integers, or steps, but not the exclusions of any other element, integer or step or group of elements, integers, or steps. The invention is designed to create a powerful yet simple way to verify user authentication, which requires only one simple user action to create “five-dimensions of identity.”

The system for multi-dimension authentication includes a mobile device, equipped with at-least one biometric sensors that run a user authentication application to performs multi-dimension authentication tasks and communicates with at least one other computing device to authenticate user to access website, web-portal, and applications with a single user action, such as interacting with a mobile device, thereby eliminating the need for multiple interaction with authentication system.

The system and method for multi-dimension authentication of the present invention is a security measure that goes beyond traditional username and password combinations adding additional layers of verification to enhance security. Multi-dimension authentication is an authentication method that requires users to provide at least two or more types of identification before granting access to a system, application, online account or any other similar service.

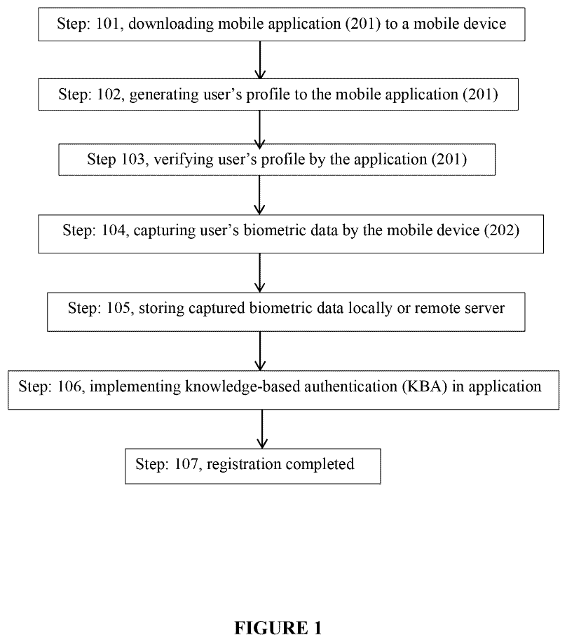

Referring now to FIG. 1, a flow-chart illustrating an embodiment of the operations made for the registration of a user to multi-dimension authentication system of the present invention, wherein registration of the user to the mobile application downloaded on a mobile device comprises the following steps, at step 101 the user downloads mobile application (201) on mobile device (202). The user may download mobile application (201) from the Internet. For example, the user using mobile device (202) may access the Apple or Google or application store over the Internet, or any other website or application that provides access to downloadable applications. Mobile applications (201) may then be installed on mobile device (202).

Upon downloading mobile application (201) on mobile device (202), at step (102) the user register and generates a user profile using mobile application (201). During registration the user provides user identification information. Alternatively, the mobile application (201) automatically retrieves user identification information from mobile device (202). The user identification information includes user's contact number, E-mail ID, user name, and password, to create an account within the mobile application. Further, In step (103) the application verify the user's identity by employing various methodology including email verification, SMS-based verification codes, One Time Password (OTP), Tokens, or any other code mechanism.

Upon successfully verifying the user's identity by the mobile application (201), at step (104) the user captures biometric data of user utilizing biometric sensors present in mobile device (202), wherein the biometric data includes but not limited to Finger print recognition in android device or Face recognition in apple device, Iris recognition, speech recognition, and behavioural recognition. In this example, the mobile application (201) may prompt user to place their thumb, fingers, or hands on a first biosensors which may be fingerprint scanner inbuilt in mobile device (202). Similarly, mobile application prompt user to record their voice in a second sensor that is a voice recorder present in mobile device (202). At step (105) the captured biometric data is stored locally on a mobile device (202) in an encrypted format to protect the privacy of user. However, in some configuration, the authentication data is saved to a remote server, thereby allowing access to user account through a remote location. Furthermore, at step (106) the registration process includes implementing knowledge based authentication (KBA) mechanism to enhance security of authentication system, thereby creating a multi-dimension authentication system. The knowledge based authentication includes choosing a secret question by selecting a unique and personal piece of information, for example a specific stock price at a particular time. Hence, the user adds an additional layer of security to their user account. This choice of secret can also serve as a means of account recovery. If the user forgets their password or encounters issues accessing their account, they can use this secret as a verification method to regain access. Finally, the registration process completes at step (107) by collecting user credentials by the user that can be utilized to access a mobile application, web-site, web-browser, or any other service.

In yet another embodiment of the present invention, The multi-dimension authentication system works with trusted and registered sources (203) which act as unique identifiers that can be used to customize risk-based workflows for any authentication. This ensures an additional layer of security and adaptability in the authentication process. Trusted sources (203) act as authenticators within the system. These sources are designated and registered during the user profile setup phase at step (102). Examples of trusted sources could include known devices, approved network connections, or authorized third-party services. The system establishes a network of trusted sources, and their validation becomes a crucial aspect of the overall authentication process.

In yet another embodiment, the system for multi-dimension authentication includes a mobile device, equipped with at-least one biometric sensors that captures user biometric data and sends to the server where the user biometric data is stored for matching. If user data matches, the mobile device is notified. The mobile device receives the authentication message, and if successful, the mobile device captures user location, Device ID, time, and sends to the server for authentication to access website, web-portal, and applications including the IoT devices or android device utilized by the user upon successful authentication by single user action.

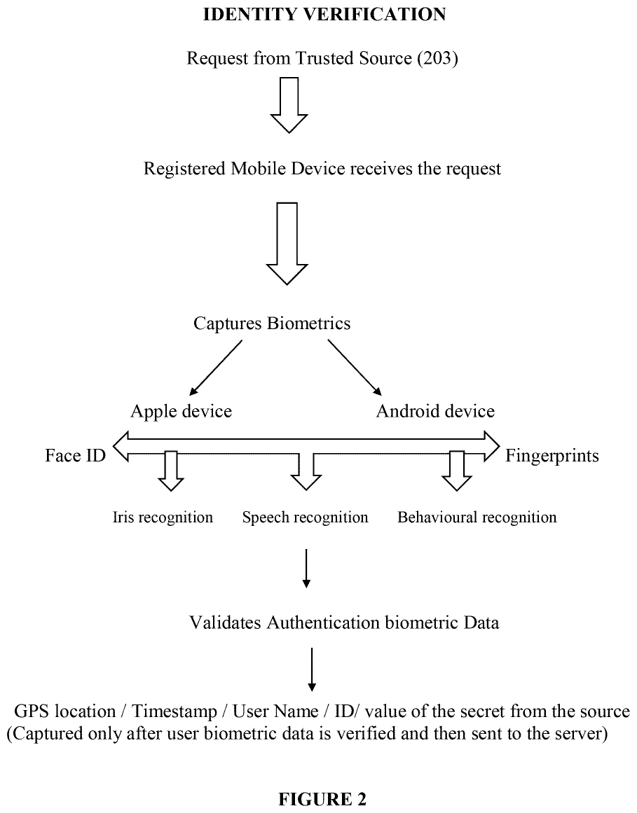

Referring now to FIG. 2, a flow-chart illustrating a step by step process for identity verification using multi-dimensions of identity from only one user action. The identity verification process comprises the steps of: a. receiving a validation request from a registered trusted source (203) to the mobile application (201); b. upon receiving the validating request to a registered mobile device, the user is prompted to authenticate their identity using biometric features present on the mobile device, wherein the authenticated biometric features includes multiple modalities such as native modalities face ID or fingerprint recognition, and other modalities such as iris recognition, speech recognition and behavioural recognition; c. authenticating user by capturing biometric data through the selected modalities; d. comparing the captured biometric data with the registered user data, either stored locally on the mobile device or retrieved from a server. After successful biometric verification, additional user details are captured. The additional user details includes current time of action, GPS coordinates indicating the location of mobile device, and the device ID. These details enhance the verification process and contribute to a multi-dimensional approach. The captured and verified user details, including biometric data, time, GPS coordinates, and device ID, are securely transmitted to the server. This server-side processing allows for centralized validation and authentication. The server receives the transmitted data and performs additional verification checks. This may include comparing the received data with the user's profile stored on the server and assessing the legitimacy of the validation request from the trusted source. If all verification steps are successful, the identity of the user is considered verified. Access or validation is granted, and the user is authenticated for the requested action.

The remote server further compares with the registered data based on location, time and device ID, validating the access is given to the user. In addition, the server may also compare the location of the device (such as laptop or other non-mobile device), based on the device IP address, with the location data received from the mobile application after the user is authenticated. This allows for ensuring that the mobile phone and non-mobile device are located in the same general area.

The utilization of trusted and registered sources in the system for multi-dimension authentication allows for the customization of risk-based workflows. The system evaluates the risk associated with each authentication attempt based on factors such as the source of the request, historical user behavior, and the nature of the accessed resource. By analyzing these risk factors, the system dynamically adjusts the authentication workflow to ensure an appropriate level of security.

The system employs dynamic risk assessment to continuously evaluate the authenticity of the user and the context of the authentication request. This dynamic approach allows the system to adapt its security measures based on the perceived level of risk. For instance, if a user is attempting to access sensitive information from an unregistered device or an unfamiliar network, the system may prompt additional verification steps.

Based on the risk assessment, the system adapts the authentication workflow. For low-risk scenarios, the process may involve a streamlined authentication with fewer steps, providing a seamless user experience. In contrast, high-risk scenarios trigger more stringent verification measures, ensuring that sensitive information remains protected against potential threats.

The present invention features a method for performing a multi-level user authentication system from only one user action for various applications and is not particularly limited to IoT (Internet of things) wherein, the sources for verification can include identity in axis management, multifactorial authentical like 2FA (two-factor authentication), solutions which replace 6-digit code with biometrics for stronger ID verification, crypto wallets, identity wallets, passwords. Furthermore, the mobile devices used for authentication can require a valid source ID, correct API keys for the source ID, a registered device ID, proven biometrics, and optional geofencing and time windowing. These five independent dimensions provide strong protection for secure data and user identity.

Additionally, the identity of user is verified before sharing important information and verification of the source and mobile number is done through an Application Programming Interface (API), to determine the valid source and that the user's data is safely captured. The user's data includes user's name, phone ID (unique to the user's phone device), location and timestamps that are safely captured which adds a lot of strength to the authentication process. The invention is further integrated with websites like identity and access management (IAM), multi-factor authentication (MFA), and Vertical market solutions.

The server further compares with the registered data based on location, time and device ID, validating this the access is given to the user. In addition, the server may also compare the location of the device (such as laptop or other non-mobile device), based on the device IP address, and with the location data received from the mobile application after the user is authenticated. This allows for ensuring that the mobile phone and non-mobile device are located in the same general area.

Another dimension of user identity at the time of registration with the app on the mobile phone, may be the secret such as stock price at 10:00AM US EST or present time if being traded, high/low temperature of the day in a city, last few digits of the zip code for the city. Immediately after authentication, the mobile app sends to Server the value of the dynamic variable and server verifies this value as the server is configured with the same setting of the variable. If the there is match at the server side of the value sent by the app, this dimension of the user identity is also verified. The mobile app and server may be configured to change this secret every day or every hour depending upon the system security requirements.

Referring now to FIG. 3 illustrates a block diagram depicting the user authentication process based on the user login credentials. The user login credential is provided during sign-up. Further, authentication steps are followed on the mobile device, where mobile device application verifies users with biometric data.

### EXAMPLE

The following example is put forth to provide those of ordinary skill in the art with a complete disclosure and description of how the methods and systems claimed herein are performed and evaluated and are intended to be purely exemplary of the invention and are not intended to limit the scope of what the inventor regards as their invention.

In the given invention the first level of authentication is through a username or user ID and a password that is provided by the user. In one embodiment of the present invention, the user ID is linked to the user's phone number. The user ID here can be the user's phone number itself.

In the second level of authentication, verification is sent on the user's phone, which can be an android or apple device. Further, the user needs to look for an authentication request and follow the required steps once the authentication is complete and the user gets access to the website.

The invention enables secure biometric authentication to the most important applications, the invention captures user biometrics at the endpoint using both native device biometrics, which can be face or fingerprints from iPhones or Androids, and other modalities, which can be speech recognition, iris recognition or behavior recognition.

During this process, it verifies the information like phone number and source through Application Programming Interface (API) to determine a valid source. Further, the user's details like the Name of the user, current location of the user, phone ID of the user, and real timestamp user are captured, and the information is sent directly to the application that requested the authentication.

Further, the system that requested Authentication will receive a response along with the device ID, and real-time, geofencing data.

What is claimed is:

1. A non-transient memory medium operatively coupled to at least one processor in a mobile device, wherein the non-transient medium is configured to store a plurality of instructions to authenticate a user and cause the at least one processor to:
a. retrieving a user identification information during a registration process, comprising user's unique identification information;
b. verifying the user's unique identity information using various methodologies including email verification, SMS-based verification codes, One-Time Password (OTP), Tokens, or other code mechanisms;
c. prompting the user to capture biometric data utilizing biometric sensors of mobile device, said biometric data including native modalities and other modalities;
d. storing the captured biometric data locally on the computing device in an encrypted format, or save to a remote server for remote access;
e. implementing a knowledge-based authentication (KBA) mechanism during registration, allowing the user to choose a unique and personal piece of information as a secret question, adding an additional layer of security to the user account;
f. working with trusted and registered sources as unique identifiers to customize risk-based workflows for user authentication, wherein said sources are designated and registered during the user profile setup phase; and
g. completing the registration process by collecting user credentials for accessing a mobile application, website, web-browser, or any other service;

2. The non-transient memory medium as claimed in claim 1, wherein the multi-dimension authentication includes capturing biometric data from the user utilizing biometric sensors, comprising fingerprint recognition, face recognition, iris recognition, speech recognition, and behavioral recognition, with verification of user information through an Application Programming Interface (API).

3. The non-transient memory medium as claimed in claim 1, wherein the trusted and registered sources is a unique identifiers to customize risk-based workflows for authentication, with said sources acting as authenticators within the system and being designated during the user profile setup phase.

4. A method for authenticating user through multi-dimension of identity from a single user action, the method comprising:
a. generating, by a registered trusted source, a request for user authentication;
b. transmitting, by the registered trusted source, the request for user authentication to a mobile device;
d. prompting, by the mobile device to capture biometric data at registered trusted source;
e. transmitting, by the registered source, the captured biometric data to mobile device;
f. comparing, by the mobile device, the captured biometric data with registered user's data;
g. validating, by the mobile device, the captured data matches with the registered user's data;
h. prompting, by mobile device to capture user's additional data including current time, GPS coordinates, and device ID;
i. transmitting, by the registered source, the captured user data to a mobile device; and
j. authenticating, by the mobile device to registered trusted source when the captured data matches with the pre-registered data, thereby allowing access to web-applications, web-sites and other services.

5. The method as claimed in claim 4, wherein the mobile device validates access based on location, time, and device ID, comparing the location of the mobile device with the device IP address to ensure authentication integrity.

6. A method for continuous risk-based authentication adaptation, comprising:
a. evaluating risk factors associated with each authentication attempt, including the source of the request, historical user behavior, and the nature of the accessed resource;
b. utilizing dynamic risk assessment to continuously evaluate the authenticity of the user and the context of the authentication request;
c. prompting additional verification steps for high-risk scenarios based on factors such as an attempt to access sensitive information from an unregistered device or an unfamiliar network;
d. streamlining the authentication workflow for low-risk scenarios by involving fewer steps to provide a seamless user experience;
e. triggering stringent verification measures for high-risk scenarios to enhance protection against potential threats;
f. modifying the authentication process based on a continuously updated risk assessment, allowing for real-time adjustments to security measures.
